(19) United States
(12) Patent Application Publication
(10) Pub. No.: US 2022/0320982 A1
(43) Pub. Date: Oct. 6, 2022

(54) MOTOR AND ELECTRICAL PRODUCT

(71) Applicant: NIDEC CORPORATION, Kyoto (JP)

(72) Inventors: Hiroshi SAMBUICHI, Kyoto (JP); Masashi SONODA, LIAONING (CN); Desen PAN, LIAONING (CN); Shuang HU, LIAONING (CN)

(73) Assignee: NIDEC CORPORATION, Kyoto (JP)

(21) Appl. No.: 17/706,599

(22) Filed: Mar. 29, 2022

(30) Foreign Application Priority Data
Mar. 31, 2021 (CN) 202110346144.2

(51) Int. Cl. H02K 24/00; H02K 11/21

(52) U.S. Cl. CPC H02K 24/00; H02K 11/21

(57) ABSTRACT

A motor is provided, including: a rotor that is arranged in a rotatable manner centered on a central axis and has a shaft and a rotor core arranged around the shaft; a stator arranged so as to face the rotor in a radial direction; and a detector located on an upper side of the rotor core in an axial direction. An upper surface of the rotor core in the axial direction has a first concave portion recessed downward in the axial direction, and a portion of the detector is inserted into the first concave portion. An electrical product including the motor is also provided.

### CROSS REFERENCE TO RELATED APPLICATIONS

The present invention claims priority under 35 U.S.C. § 119 to Chinese Application No. 202110346144.2 filed on Mar. 31, 2021 the entire content of which is incorporated herein by reference.

### FIELD OF THE INVENTION

An example of the present application relates to the mechanical and electrical field, and particularly to a motor and an electrical product.

### BACKGROUND

In a conventional motor structure, a detector is located on the upper side of a rotor core in an axial direction, and a wall portion of the detector extending along the axial direction is tightly fitted to a shaft.

It should be noted that the above description of the technical background only describes the technical solution of the present application clearly and thoroughly and facilitates the understanding of those skilled in the art. The above technical solution should not be considered known to those skilled in the art solely because these solutions are described in the related art part of the present application.

The inventors have found that because the detector is located on the upper side of the rotor core, it is necessary to independently secure an arrangement space inside the motor for the detector, which is disadvantageous to the miniaturization of the motor.

### SUMMARY

One aspect of the example of the present application provides a motor, including:

a rotor that is arranged in a rotatable manner centered on a central axis and has a shaft and a rotor core arranged around the shaft;
a stator arranged so as to face the rotor in a radial direction; and
a detector located on the upper side of the rotor core in an axial direction;
wherein an upper surface of the rotor core in the axial direction has a first concave portion recessed downward in the axial direction, and a portion of the detector is inserted into the first concave portion.

Another aspect of the example of the present application provides an electrical product having the motor of any example according to the one aspect described above.

The above and other elements, features, steps, characteristics and advantages of the present disclosure will become more apparent from the following detailed description of the preferred embodiments with reference to the attached drawings.

### BRIEF DESCRIPTION OF THE DRAWINGS

The appended drawings are used to provide a further understanding on an example of the present application, and are used to constitute a part of the specification, illustrate an exemplary embodiment of the present application, and explain the principles of the present application along with text description. Obviously, the drawings in the following description are only some examples of the present application, and those skilled in the art may obtain other drawings based on these drawings even without creative labor. In the drawings,

FIG. 1 is a schematic diagram of an example of a motor according to the example of the present application;

FIG. 2 is a schematic diagram of an axial cross section of the motor shown in FIG. 1;

FIG. 3 is a schematic diagram of an axial cross section of a rotor core and a detector;

FIG. 4 is a schematic diagram of the rotor core of the motor shown in FIG. 1;

FIG. 5 is a plan view of the rotor core shown in FIG. 4;

FIG. 6 is a schematic diagram of the detector of the motor shown in FIG. 1; and

FIG. 7 is a plan view of the detector shown in FIG. 6.

### DETAILED DESCRIPTION

With reference to the drawings, the above-described features and other features of the present application are clarified by the following specification. An exemplary embodiment of the present application, which represents some exemplary embodiments in which the principles of the present application may be adopted, is specifically disclosed in the specification and drawings. It should be understood that the present application is not limited to the described exemplary embodiment, and the present application includes all modifications, variations, and equivalents that fall within the scope of the attached claims.

In the example of the present application, the expression “and/or” includes any one or all combinations of one type or plural types of terms listed in connection therewith. The expressions such as “contain” “include” “have” and the like refer to the existence of the stated feature, element, component part, or assembly, but do not exclude the presence or addition of one or a plurality of other features, elements, component parts, or assemblies.

In the example of the present application, the singular form such as “one”, “this” or the like may include the plural form. For example, “one kind of” or “one type of” should be broadly understood and is not limited to the meaning of “one”. In addition, the expression “the . . . mentioned above” should be understood to include both the singular form and the plural form unless otherwise specified before and after. Also, the expression “according to” should be understood as “at least partially . . . according to” and the expression “based on” should be understood as “at least partially . . . based on” unless otherwise stated before and after.

Note that, in the following description of the present application, for convenience of description, a direction extending along a central axis O of a motor or a direction parallel to the central axis O is referred to as “axial direction”; a direction oriented to a cover portion of the motor from the bottom of the motor is referred to as “above”, “upper side”, “upper side in the axial direction” or “one side in the axial direction”; a direction oriented to the bottom of the motor from the cover portion of the motor is referred to as “below”, “lower side”, “lower side in the axial direction” or “the other side in the axial direction”; a radius direction centered on the central axis O is referred to as “radial direction”; a direction of getting close to the central axis O is referred to as “inner side in the radial direction”; a direction of getting away from the central axis O is referred to as “outer side in the radial direction”; and a direction surrounding the central axis O is referred to as “circumferential direction”. However, it is worth noting that these are used only for convenience of description and do not limit the orientation of the motor during use and manufacture.

Hereinafter, the embodiment of the example of the present application is described with reference to the drawings.

The example of the present application provides a motor.

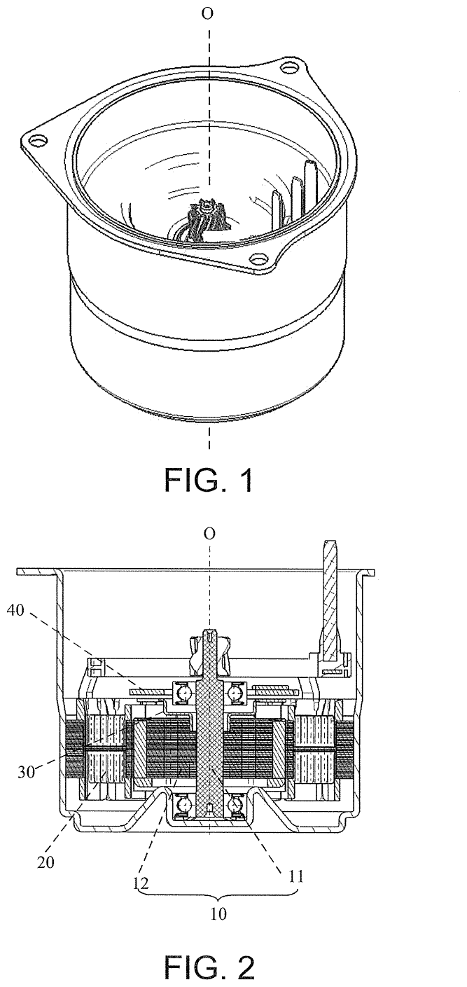

FIG. 1 is a schematic diagram of an example of the motor according to the example of the present application, and FIG. 2 is a schematic diagram of an axial cross section of the motor shown in FIG. 1. As shown in FIGS. 1 and 2, the motor includes a rotor 10 arranged in a rotatable manner centered on the central axis O and a stator 20 facing the rotor 10 in the radial direction, and the rotor 10 has a shaft 11 and a rotor core 12 arranged around the shaft 11. As shown in FIGS. 1 and 2, the motor further includes a detector 30 located on the upper side of the rotor core 12 in the axial direction.

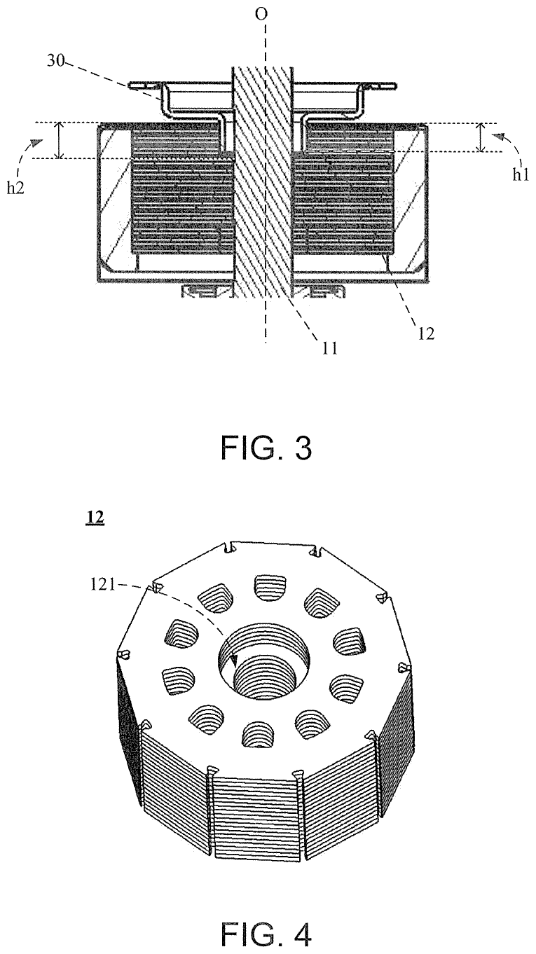

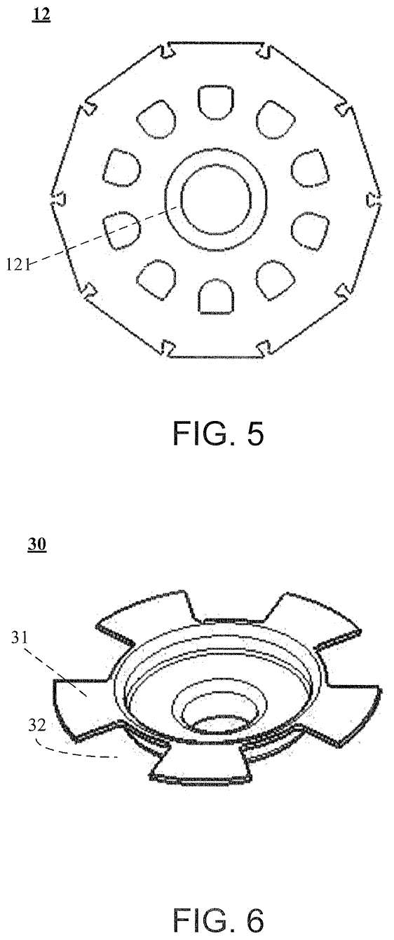

FIG. 3 is a schematic diagram of an axial cross section of the rotor core and the detector according to the example of the present application, FIG. 4 is a schematic diagram of the rotor core of the motor shown in FIG. 1, and FIG. 5 is a plan view of the rotor core shown in FIG. 4.

As shown in FIGS. 3 to 5, in the example of the present application, an upper surface of the rotor core 12 in the axial direction has a first concave portion 121 recessed downward in the axial direction, and a portion of the detector 30 is inserted into the first concave portion 121.

Accordingly, a length of a bearing is shortened by inserting the detector into the concave portion (the first concave portion 121) of the rotor core, thereby realizing the miniaturization of the motor.

In some examples, the detector 30 is tightly fitted to the rotor core 12, that is, the detector 30 is inserted into the first concave portion 121 of the rotor core 12 by means of tight fit to achieve fixation with the rotor core 12.

In some examples, as shown in FIG. 5, the first concave portion 121 is defined at a central position of the rotor core 12 in the radial direction, and an outer periphery of a portion of the detector 30 inserted into the first concave portion 121 and an inner periphery of the rotor core 12 surrounding the first concave portion 121 are tightly fitted to each other. Thereby, the detector 30 and the rotor core 12 are fixed, and the detector 30 and the rotor core 12 do not come off due to thermal expansion and contraction caused by a temperature change.

In some examples, as shown in FIG. 3, a length h1 of the portion of the detector 30 inserted into the first concave portion 121 is shorter than a depth h2 of the first concave portion 121. Thereby, a space is secured for adjusting the position of the detector 30 in consideration of the expansion coefficient of the detector 30.

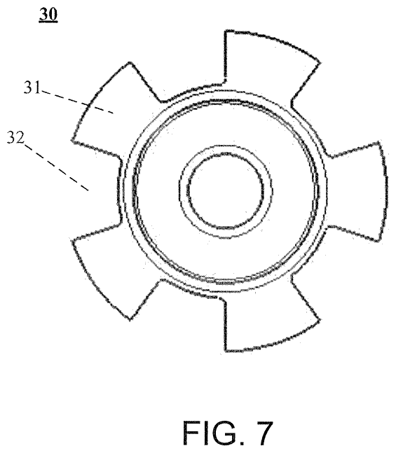

FIG. 6 is a schematic diagram of the detector of the motor shown in FIG. 1, and FIG. 7 is a plan view of the detector shown in FIG. 6.

In some examples, as shown in FIG. 2, the motor further includes a circuit board 40. As shown in FIGS. 6 and 7, the detector 30 has a detection portion 31 being disk-shaped or substantially disk-shaped, and an outer periphery of the detection portion 31 has a gap 32 recessed inward in the radial direction. As shown in FIG. 2, the gap 32 and the circuit board 40 are arranged so as to face each other in the axial direction. Accordingly, by detecting the number of passes of the gap 32 by the circuit board 40, the rotation speed of the motor is determined. The present application does not limit the number and parameter of the gap 32.

In some examples, as shown in FIG. 2, there is a clearance between the detection portion 31 and the rotor core 12 in the axial direction. This avoids direct contact between a sensor and the rotor core 12.

In some examples, as shown in FIG. 2, there is also a clearance between the detector 30 and the shaft 11. This is convenient for assembling the detector 30, and by accommodating lubricating oil in the clearance, the operation of the shaft 11 may be facilitated.

In some examples, at a position corresponding to the first concave portion 121 on a lower surface of the rotor core 12, there is a second concave portion (not shown) recessed upward in the axial direction. A depth of the second concave portion and the depth of the first concave portion 121 may be the same, that is, there are concave portions on both sides of the rotor core 12 in the axial direction, which not only reduces the weight of the motor, but also further facilitates manufacture and installation because the rotor core 12 has a symmetrical structure. The present application is not limited thereto, and the depth of the second concave portion may be set different from that of the first concave portion 121 in order to fulfil other functions.

It is worth noting that the above description is only an exemplary description of the configuration of the motor related to the present application, the present application is not limited thereto, and appropriate variations may be made based on each of the above examples. In addition, the above description is only an exemplary description of each member, the present application is not limited thereto, and related techniques may be referred to for the specific contents of each member. In addition, members not shown in FIGS. 1 to 7 may be added, or one or a plurality of members in FIGS. 1 to 7 may be reduced. As for other configurations and structures of the motor, related techniques may be referred to, and the description is omitted herein.

According to the example of the present application, the length of the bearing is shortened by inserting the detector into the concave portion of the rotor core, thereby realizing the miniaturization of the motor.

An example of the present application provides an electrical product having the motor described in the example of the first aspect. The structure of the motor is described in detail in the example of the first aspect, the contents thereof are incorporated here, and thus the description thereof is omitted here.

In the example of the present application, the electrical product may be any electrical equipment in which a motor is installed. For example, the electrical product may be a household electrical appliance such as an indoor unit of an air conditioner, an outdoor unit of an air conditioner, a water supply machine, a washing machine, a vacuum cleaner, a compressor, a blower, and a mixer, may be industrial equipment such as a pump, a conveyor, an elevator, a standard industrial general-purpose mounter, a wind generator, a grinder, a traction motor, or various information processing equipment, and may be each member of an automobile such as an electric power steering system of an automobile, a sunroof adjuster of an automobile, a seat adjuster, a transmission, and a brake device.

Although the present application has been described above in association with the exemplary embodiment, those skilled in the art should understand that these descriptions are all exemplary and are not restrictions on the scope of protection of the present application. Those skilled in the art may make various variations and modifications to the present application based on the gist and principle of the present application, and these variations and modifications are also within the scope of the present application.

The exemplary embodiments of the present application have been described above with reference to the drawings. Many features and advantages of these exemplary embodiments are obvious according to the detailed specification. Therefore, the attached claims are to cover all those features and advantages of these exemplary embodiments that fall within the true gist and scope. Moreover, because those skilled in the art are able to easily conceive of many modifications and changes, the exemplary embodiments of the present application are not limited to the precise structures and operations as illustrated and described, and encompass all suitable modifications and equivalents that fall within the scope thereof.

Features of the above-described preferred embodiments and the modifications thereof may be combined appropriately as long as no conflict arises. While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor, comprising:
a rotor that is arranged in a rotatable manner centered on a central axis and has a shaft and a rotor core arranged around the shaft;
a stator arranged so as to face the rotor in a radial direction; and
a detector located on an upper side of the rotor core in an axial direction;
wherein an upper surface of the rotor core in the axial direction has a first concave portion recessed downward in the axial direction, and a portion of the detector is inserted into the first concave portion.

2. The motor according to claim 1, wherein the detector is tightly fitted to the rotor core.

3. The motor according to claim 2, wherein the first concave portion is defined at a central position of the rotor core in the radial direction; and
an outer periphery of the portion of the detector inserted into the first concave portion and an inner periphery of the rotor core surrounding the first concave portion are tightly fitted to each other.

4. The motor according to claim 1, wherein a length of the portion of the detector inserted into the first concave portion is shorter than a depth of the first concave portion.

5. The motor according to claim 1, further comprising a circuit board, wherein the detector has a detection portion being disk-shaped, an outer periphery of the detection portion has a gap recessed inward in the radial direction, and the gap and the circuit board are arranged so as to face each other in the axial direction.

6. The motor according to claim 5, wherein there is a clearance between the detection portion and the rotor core in the axial direction.

7. The motor according to claim 1, wherein there is a clearance between the detector and the shaft.

8. The motor according to claim 1, wherein at a position corresponding to the first concave portion on a lower surface of the rotor core, there is a second concave portion recessed upward in the axial direction.

9. An electrical product, comprising the motor according to claim 1.
